(19) United States
(12) Patent Application Publication
(10) Pub. No.: US 2009/0302660 A1
(43) Pub. Date: Dec. 10, 2009

(54) HEADREST FOR A VEHICLE SEAT

(75) Inventors: Rune Karlberg, Bottnaryd (SE); Robert Wain, Burton upon Trent (GB)

Correspondence Address: EDWARDS ANGELL PALMER & DODGE LLP, P.O. BOX 55874, BOSTON, MA, 02205, US

(73) Assignee: KONGSBERG AUTOMOTIVE, Kongsberg (NO)

(21) Appl. No.: 11/719,271

(22) PCT Filed: Nov. 30, 2005
(86) PCT No.: PCT/SE05/01795

§ 371 Date: Aug. 10, 2009

Related U.S. Application Data
(60) Provisional application No. 60/593,049, filed on Dec. 3, 2004.

(30) Foreign Application Priority Data
Dec. 1, 2004 (SE) 0402919-5

(51) Int. Cl. B60N 2/48

(52) U.S. Cl. 297/404; 297/407

(57) ABSTRACT

The invention relates to a headrest (100) for a vehicle seat, comprising a fixed part (110) for attachment in a vehicle seat and at least a first moving part (115), which moving part (115) is movably mounted in amounting (120) in the fixed part so that it can be moved between a first and a second position relative to the fixed part (110). The movement of the moving part (115) from the said first position to the said second position is achieved by means of an inflatable element (130) in the headrest (100), which is inflated by compressed air and thus expands, and the first moving part (115) is maintained in the said second position by means of the inflated inflatable element (130).

### TECHNICAL FIELD

The invention relates to a headrest for a vehicle seat, comprising a fixed part for attachment in a vehicle seat, and at least a first moving part. The first moving part is movably mounted in a mounting in the fixed part, so that it can be moved between a first and a second position relative to the fixed part.

### BACKGROUND ART

Headrests for vehicle seats are well known, and often comprise moving parts, so called “wings”, which are movably secured in the headrest, and the angular position of which relative to the headrest can be adjusted according to requirement and can thus provide support for the head in the lateral direction.

A drawback with currently known solutions as regards moving wings in headrests is that they have to be adjusted by hand, which can endanger traffic and lead to uncomfortable movements. A further drawback with currently known solutions is that the wings are locked in a set angular position by means of friction, mechanical engagements or the like, which leads to wear, and thus to deteriorated locking function after a period of use.

### DISCLOSURE OF INVENTION

There is therefore a need for a solution by which a moving wing in a headrest can be manoeuvred in a manner which offers greater traffic safety than hitherto known solutions. Such a solution should expediently also offer improved functionality which is not at risk of being degraded over time.

This need is met by the present invention in that it discloses a headrest for a vehicle seat, comprising a fixed part for attachment in a vehicle seat and a least a first moving part. The moving part is movably mounted in a mounting in the fixed part, so that it can be moved between a first and a second position relative to the fixed part, and the movement of the moving part from the said first position to the said second position is achieved by means of an inflatable element in the headrest, which is inflated by compressed air and thus expands. Furthermore, the moving part is maintained in the said second position by means of the inflated inflatable element.

By means of the invention, a solution is therefore offered in which the movement of wings or similar moving parts on a headrest can be manoeuvred by means of a control device which can be disposed in an, in principle, arbitrary location on or adjacent to the vehicle seat, since the control device can be designed to control the inflation or deflation of the inflatable element.

Furthermore, the moving part—the wing—is maintained in a desired position by the inflated inflatable element between the wing and a fixed part in the headrest, which eliminates the need for solutions reliant upon friction for the locking function. A locking function is thus created which does not suffer from wear in the same way as a friction solution.

### BRIEF DESCRIPTION OF DRAWINGS

The invention will be described in greater detail in the following description with reference to the appended drawings, in which:

FIG. 1 shows a headrest according to the invention, viewed from the front, and

FIG. 2 shows the headrest from FIG. 1, viewed obliquely from above on one side, and

FIG. 3 shows the headrest from FIG. 1 and FIG. 2 from the side, and

FIG. 4 shows the headrest according to the invention, viewed from above, and

FIG. 5 shows the headrest according to the invention in greater detail from the rear, and

FIG. 6 shows the same as FIG. 5 but from the front, and

FIG. 7 shows an alternative embodiment at the same angle as FIG. 3.

### MODE(S) FOR CARRYING OUT THE INVENTION

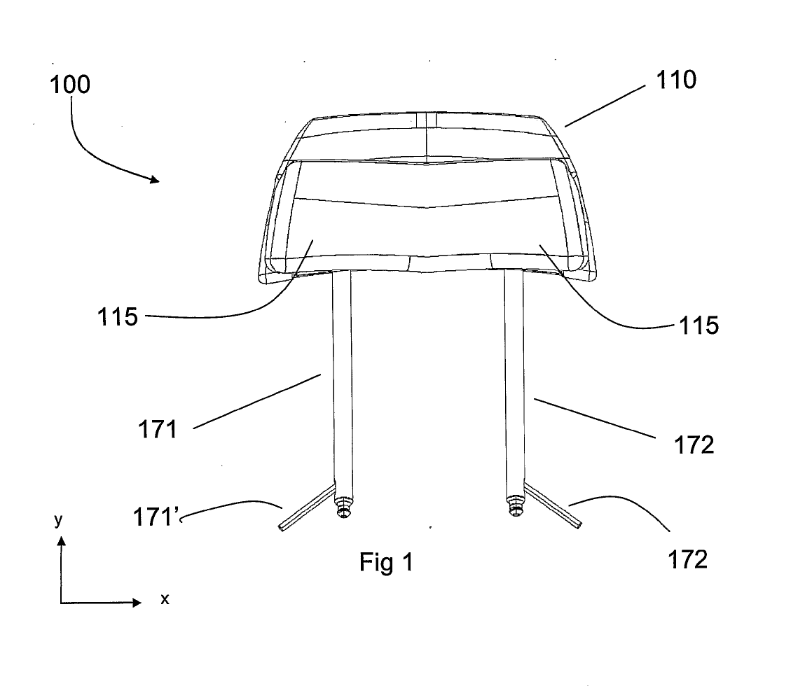

In FIG. 1, a headrest 100 according to the invention is shown. As can be seen, and as will be described in greater detail further below, the headrest 100 comprises a fixed part 110 for attachment in a vehicle seat, and at least a first moving part 115. Furthermore, the headrest can comprise, or be connected to, a first 171 and a second leg 172.

In FIG. 1 and throughout the description, the headrest is shown to comprise two moving parts 115, symmetrically arranged in the headrest 100, which is a preferred embodiment. It will be appreciated, however, that the number of moving parts, as well as their positioning in the headrest, can in principle be freely varied within the scope of the invention.

The moving part 115 is disposed in a mounting (not shown in FIG. 1) in the fixed part 110 in such a way that the moving part 115 can be moved forward and back relative to the back of the head of the person who is to sit in the seat, and can thus offer at least a first and a second position for the head. Such moving parts, “wings”, are previously known, but the background art for such moving parts exhibits a number of problems: known wings are manoeuvred between their various positions by hand, which, if it is the driver of the vehicle who adjusts the wings on his headrest, results in the car only being steered with one hand, which is dangerous to traffic. Furthermore, the wings are held in their tilted-out positions by different types of friction locks, engagement parts or the like, which means that the locking function is degraded overtime.

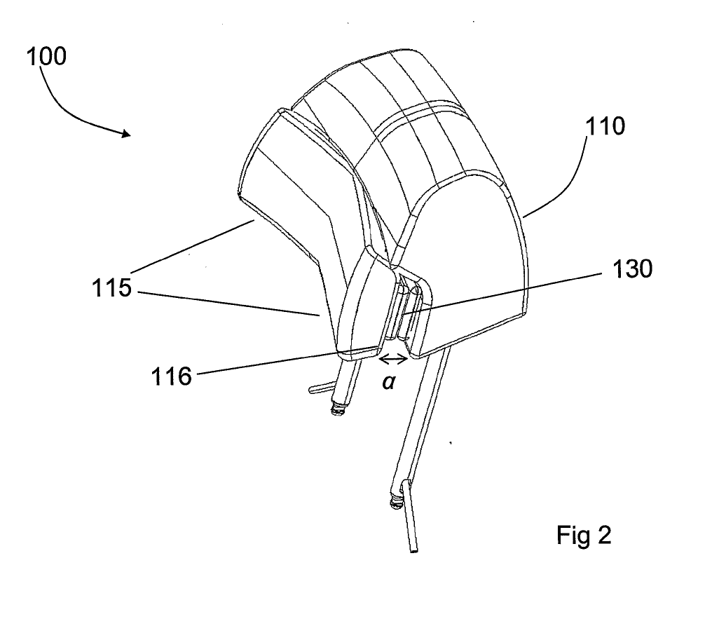

In FIG. 2, the headrest 100 according to the invention is shown, viewed obliquely from above on one side. This drawing reveals one of the distinguishing features of the present invention which solves the aforementioned problems with known moving parts in headrests: the headrest 100 according to the invention comprises at least one inflatable element 130, which can be inflated by compressed air and which is disposed in the headrest 100 such that, owing to its expansion, it can guide the moving part 115 from a first, inner position to at least a second, outer position. The use of the inflatable element 130 also allows continuous adjustment of the moving part between the first, inner and the second, outer position, if so desired.

The moving part 115 will further be maintained in a second, outer position by means of the expanded inflatable element 130, which means that friction locks etc. are not required. This type of locking is advantageous, since it is not degraded over time in the same way as previously known locking mechanisms for “wings”.

The actual mechanism according to the invention for guiding the wing from the first to the second position is also advantageous compared with known solutions for the same thing, owing to a number of different factors: firstly, the inflation of the element 130 can be done by means of an existing compressed air system in the vehicle or even in the vehicle seat, if so desired, which simplifies the design and keeps down the cost, secondly the control of the wing movements by means of compressed air can be remote-controlled from a control device which can be placed in an, in principle, arbitrary location in the vehicle. This results in a manoeuvring of the wing movements which offers considerably greater traffic safety then previously.

The existing compressed air system which, in a preferred embodiment of the invention, is used to manoeuvre the wings is a compressed air system which is used in the vehicle seat to adjust, for example, lumbar supports and/or conduct massage.

As is shown in FIG. 2, the inflation of the inflatable element 130 brings about an increase in an angle α between an outer edge 116 of the first moving part 115 and the fixed part 110, which is another way of saying that “the wing” 115 is led out from the fixed part 110 by means of the inflatable element 130.

As is indicated in FIG. 2, the inflatable element 130 is disposed between the first moving part 115 and the fixed part 110 with an extent stretching from a mounting (not shown) for the wing 115 in the headrest 110 to the said outer edge 116 of the moving part 115, the inflatable element 130 being shaped such that its expansion in the course of the inflation is proportional over its extent to the said increased angle α. In other words, the inflatable element will expand in different magnitude along the extent stretching from the mounting to the outer edge 116.

The supply of compressed air to the inflatable element 130 can be managed in a variety of ways within the scope of the invention, but in a preferred embodiment this is done by means of a solenoid valve which regulates the compressed air supply from a pump or an ordinary compressed air system to the element 130. The solenoid valve per se can be operated from a dedicated control device in the vehicle, which will be described elsewhere in the description.

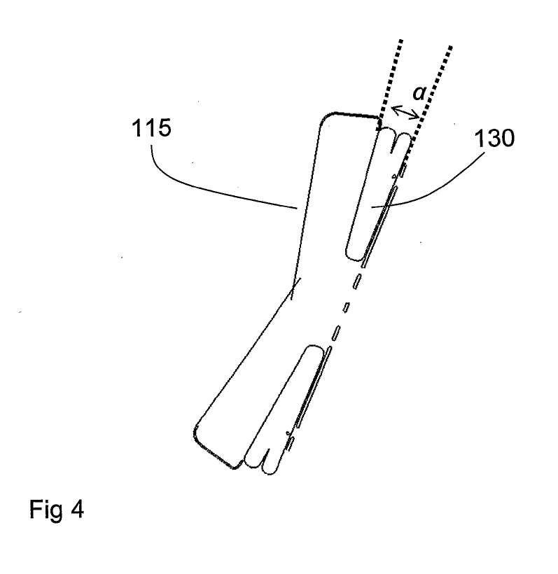

In FIG. 4, the headrest 100 is shown, for the sake of completeness, from above. The moving part 115 and the inflatable element are clearly apparent, as is the positioning of the inflatable element in relation to the wing 115, as well as the angle α controlled by the inflatable element 130.

So far it has merely been stated how the wing 115 is made to move outward, in other words from the first to the second position, by means of the invention. When the wing is to be returned to an inner position, this can be done, for example, by the valve quite simply being opened, but this would mean that the element 130 could only be deflated to atmospheric pressure. Another solution would be polarity reversal of the said pump, but in a preferred embodiment of the invention the wing 115 is returned to an inner position from an outer position by the fact that the headrest 100 further comprises means (not shown) for returning the wing 115 to the first position if the element 130 is deflated due to opening of the valve.

These means for returning the wing 115 can be realized in a variety of ways, but are expediently some form of elastic element which is elongated upon expansion of the element 130 and which, on the basis of its contraction, endeavours to return the wing 115 to an inner position. Another possible component to use for the return of the wing 115 would be so-called clock springs, in other words a spring having a linear elastic action.

The solenoid and the pump which have been described above can be placed closely adjacent to one another, or separately, in different locations relative to the headrest 100. In one possible embodiment of the headrest 100, both the solenoid and the pump, however, are seated in the headrest 100. To enable whoever is seated in the vehicle seat to manoeuvre the wing or wings, in another and easily accessible location there is disposed a separate control device by which the solenoid and/or the pump can be operated. In this case (remote control of solenoid and/or pump), some form of connection to the headrest 100 is required, preferably one connection for compressed air and one for electrical signals to the solenoid.

An expedient way of arranging connections for electrical signals and/or compressed air to the headrest 100 can be described with renewed reference to FIG. 1: as is shown in this drawing, the headrest 100 is expediently equipped with or connected to a vehicle seat by a first 171 and a second 172 “leg”. Expediently, these legs are used to carry up electrical signals and compressed air to the headrest 100, where they are connected to the solenoid and the pump. The supply of compressed air and electrical signals via the legs 171, 172 is shown in FIG. 1 by means of a “tube” 171′, 172′ in each leg 171, 172.

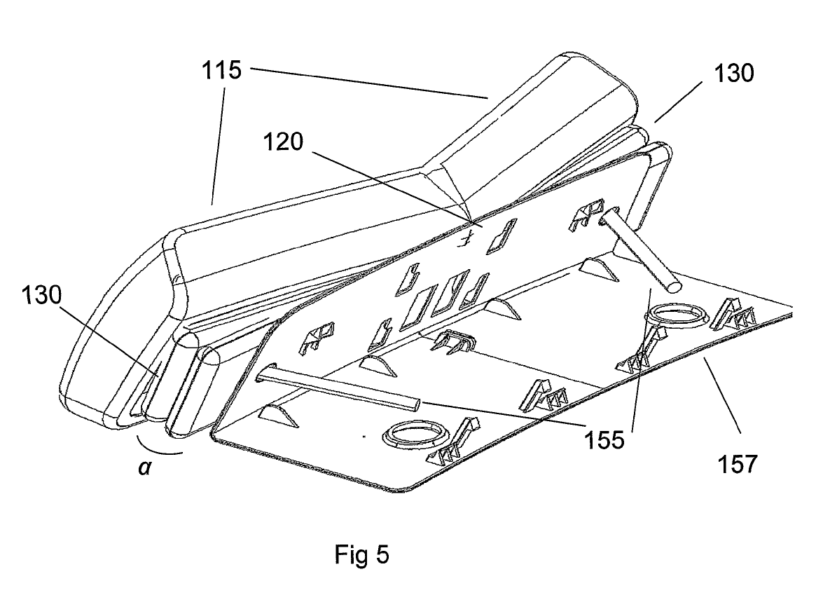

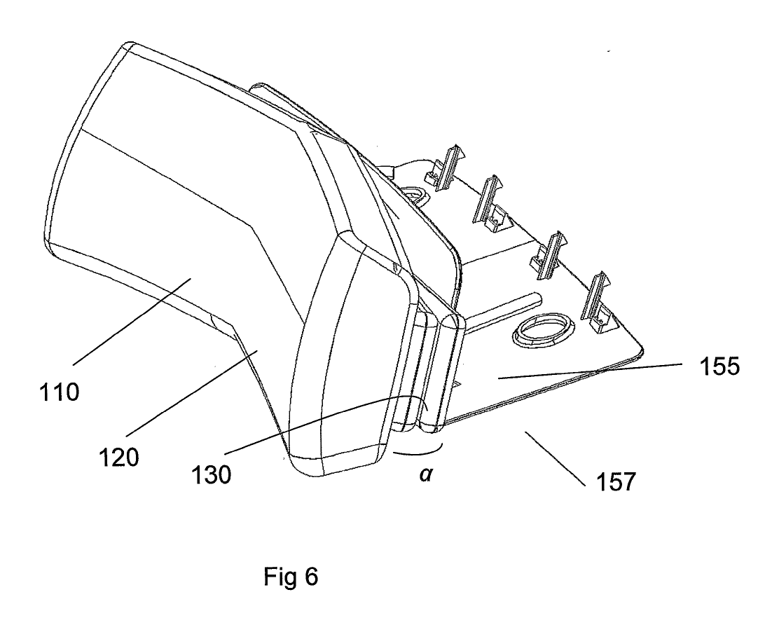

In FIGS. 5 and 6, a headrest according to the invention is shown in somewhat greater detail than previously, at two different angles: in FIG. 5 from the rear and in FIG. 6 from the front. These drawings reveal still more clearly the “double-sided aspect” in a preferred embodiment of the invention, in other words that two “wings” 115 are seated on either side of a hinge 120 in the middle of the headrest 100 and that between each wing and the other headrest there is disposed an inflatable element 130 as described above.

In this embodiment, as can be seen from FIG. 5 and 6, the hinge or the mounting 120 is arranged such that the wing or wings will be able to be moved in a direction which means that the angle between the outer edge 116 of the wing and the fixed part is altered, so that the wing 115 will be able to be adjusted to provide different positions on one side of the head of an imaginary person. The wing 115 will therefore be able to be moved about an imaginary axis, whose principal extent coincides with the vertical direction in a vehicle in which the headrest 100 is intended to be disposed. This axis is shown as the “y-axis” in the system of coordinates in FIG. 1.

Lines 155 for compressed air to each wing 115 are clearly apparent in the drawings. It is these lines which are controlled by a solenoid with the aid of a pump. Furthermore, FIGS. 5 and 6 show a supporting plate 157 for the headrest 100, which can form part of the construction but which does not need to do so, but rather has merely been included to illustrate an exemplary embodiment.

One feature of the invention which has continuously been shown in the figures but which has not been commented on is the fact that the inflatable element 130 in FIGS. 2-6 comprises two separate elements, two “bellows” or chambers. The number of chambers in each element is expediently a function of the maximum angle α which the wing 115 may desirably assume relative to the other headrest 100. It lies within the scope of the invention to make the inflatable elements consist of a number of such chambers, alternatively for the inflatable elements merely to comprise a single chamber, this being determined by the required tilt-out angle for the “wing” 115.

The reason for the multi-chambered configuration is that a single “bag” in the inflatable element would give a balloon-like sphere when fully inflated, with little contact area against the wing 115. Furthermore, material used in “the bag” would not be capable of inflating far enough. The construction in question also gives a larger contact area against the wing 115 and, at the same time, the correct length when inflated.

Should the inflatable elements 130 comprise two or more chambers, these can each be arranged such that they do not become a communicating system. The chambers can also be made to inflate to different degrees or can be made to be individually controllable.

Another option is to obtain a certain elastic effect in the wing 115 relative to the other headrest 100 by not fully inflating one or more chambers.

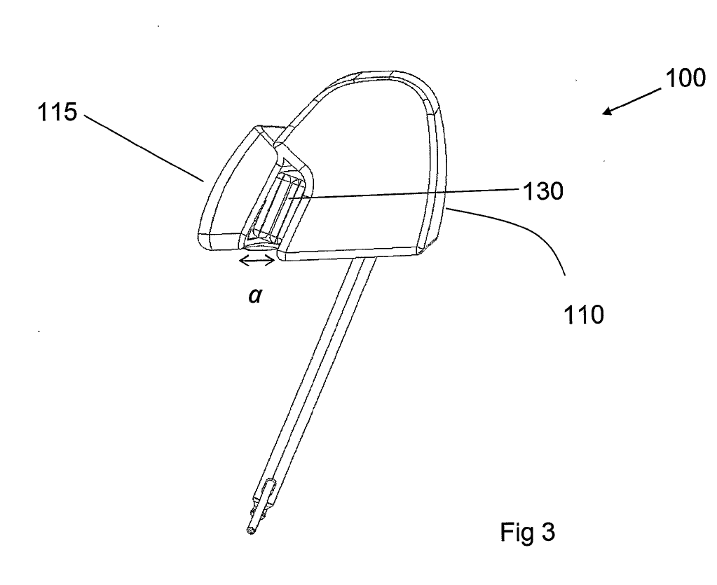

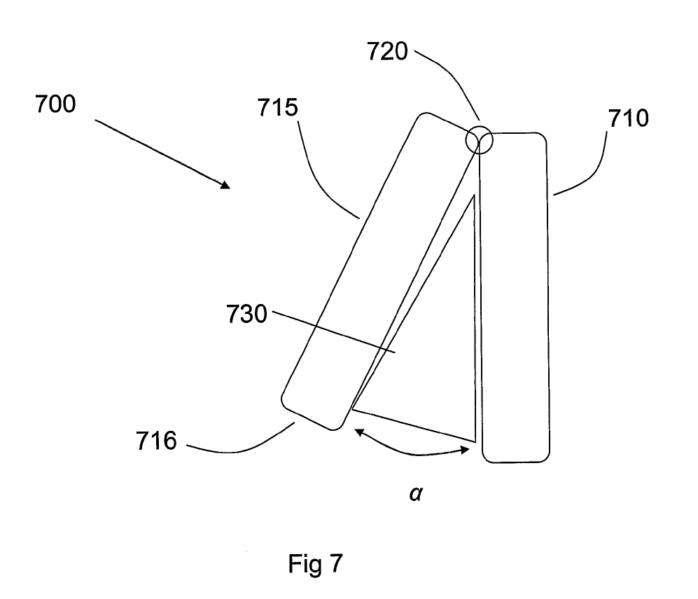

In FIG. 7, an alternative embodiment 700 of the invention is shown. FIG. 7 symbolically shows the headrest 700 viewed in substantially the same side perspective as in FIG. 3. This embodiment, too, comprises a fixed part 710 for attachment in a vehicle seat, a moving part 715, a hinge 720 about which the moving part 715 is mounted, and an inflatable element 730. The difference between the embodiment 700 and the embodiments previously shown can be seen from FIG. 7; in this embodiment, the hinge 720 is arranged such that the movement of the wing means that the distance between a bottom edge 717 of the wing 715 and the head of an imaginary user is altered. The principal movement of the wing is therefore about the top edge of the fixed part, where “top edge” here means that which constitutes the top edge when the headrest 700 is disposed in an imaginary vehicle seat.

In a further embodiment of the invention, it is naturally possible to arrange the hinge 720 such that the movement of the wing means that the distance between a top edge 717 of the wing 715 and the head of an imaginary user is altered. The principle movement of the wing is in this case about the bottom edge of the fixed part, where “bottom edge” here means that which constitutes the bottom edge when the headrest 700 is disposed in an imaginary vehicle seat.

Another way of describing the embodiment 700, and its said alternatives, is that the mounting 720 allows for the wing 715 to be moved in a direction which means that the distance between the back of the head of an imaginary user and the fixed part of the headrest 710 is varied. The wing 715 will therefore be able to be moved about an imaginary axis, whose principal direction of extent coincides with the lateral direction in a vehicle in which the headrest 100 is intended to be disposed. This axis is shown as the “x-axis” in the system of coordinates in FIG. 1.

1. A headrest (100, 700) for a vehicle seat, comprising a fixed part (110, 710) for attachment in a vehicle seat and at least a first moving part (115, 715), which moving part (115, 715) is movably mounted in a mounting (120, 720) in the fixed part, so that it can be moved between a first and a second position relative to the fixed part (110, 710), in which headrest the movement of the moving part (115, 715) from the said first position to the said second position is achieved by means of an inflatable element (130, 730) in the headrest (100, 700), which is inflated by compressed air and thus expands, and in which the first moving part (115, 715) is maintained in said second position by means of the inflated inflatable element (130, 730), which headrest is characterized in that the mounting (120) is arranged such that the first moving part (115) will be able to be adjusted to provide different positions on one side of the head of an imaginary person, in other words movement about an imaginary axis (y), whose principal extent coincides with the vertical direction in a vehicle in which the headrest (100) is intended to be disposed.

2. The headrest (100, 700) according to claim 1, in which the inflation of the inflatable element (130, 730) brings about an increase in an angle (α) between an outer edge (116) of the first moving part (115, 715) and the fixed part (110, 710), and in which the inflatable element (130, 730) is disposed between the first moving part (115, 715) and the fixed part (110, 710) with an extent stretching to the said outer edge (116, 716) of the moving part (115, 715), the inflatable element (130, 730) being shaped such that its expansion in the course of the inflation is proportional over its extent to the said increased angle (α).

3. The headrest (100, 700) according to either one of claim 1 or 2, in which the inflatable element (130, 730) further comprises a valve which regulates the compressed air supply to the element (130, 730), and in which the headrest (100, 700) further comprises means for returning the moving part (115, 715) to the first position if the part is deflated due to opening of said valve.

4. The headrest (100, 700) according to claim 3, in which the means for returning the first moving part (115, 715) comprise an elastic part, which is elongated upon the inflation of the element and which endeavours to be contracted and thus return the element to the first position when the valve is opened.

5. The headrest (100, 700) according to any one of claims 1-4, further comprising a connection (165) for external control devices, by means of which connection the inflation or deflation of the inflatable element (130) can be controlled.

6. The headrest (100, 700) according to any one of claims 1-5, further comprising two legs (171, 172) for attachment in a seat back of a vehicle, in which the one leg comprises means for supplying compressed air and the other leg comprises connections for controlling the inflation or deflation of the inflatable element.
